(19) United States
(12) Patent Application Publication
(10) Pub. No.: US 2025/0309399 A1
(43) Pub. Date: Oct. 2, 2025

(54) POWER STORAGE DEVICE

(71) Applicant: TOYOTA JIDOSHA KABUSHIKI KAISHA, Aichi-ken (JP)

(72) Inventor: Satomi YAMAMOTO, Miyoshi-shi (JP)

(21) Appl. No.: 19/052,280

(22) Filed: Feb. 13, 2025

(30) Foreign Application Priority Data
Mar. 26, 2024 (JP) 2024-049314

(51) Int. Cl. H01M 10/6555; H01M 10/48; H01M 10/613; H01M 10/647; H01M 10/653; H01M 10/658; H01M 50/209

(52) U.S. Cl. CPC H01M 10/6555; H01M 10/486; H01M 10/613; H01M 10/647; H01M 10/653; H01M 10/658; H01M 50/209

(57) ABSTRACT

In a power storage device, a first heat transfer member is adjacent to a first cell on a second direction side opposite to a first direction side of the first cell. A second heat transfer member is adjacent to a second cell on a second direction side of the second cell. A heat insulating member is made of a material having a thermal conductivity lower than that of each of the first heat transfer member and the second heat transfer member. The heat insulating member is located on a first direction side of the battery cell group. A cooling portion is in contact with the first heat transfer member and the second heat transfer member. In a third direction, a thermal resistance of the first heat transfer member is lower than a thermal resistance of the second heat transfer member.

### CROSS REFERENCE TO RELATED APPLICATIONS

This nonprovisional application is based on Japanese Patent Application No. 2024-049314 filed on Mar. 26, 2024 with the Japan Patent Office, the entire contents of which are hereby incorporated by reference.

### BACKGROUND

### Field

The present disclosure relates to a power storage device.

### Description of the Background Art

A battery pack disclosed in Japanese National Patent Publication No. 2022-549926 includes a battery module stack, a pack case, a heatsink, a heat spreader sheet, and a thermal insulation pad. The battery module stack includes a first battery module and a second battery module. The first battery module and the second battery module are disposed to be adjacent to each other. The heatsink is interposed between a lower part of the battery module stack and the pack case, or is in contact with a lower part of the pack case. The heat spreader sheet is interposed between the first battery module and the second battery module. The thermal insulation pad is interposed between the first battery module and the second battery module. The heat spreader sheet includes a first heat spreader sheet and a second heat spreader sheet. The first heat spreader sheet is adjacent to the first battery module. The second heat spreader sheet is adjacent to the second battery module.

### SUMMARY

In a conventional power storage device, a member that achieves thermal insulation between battery cell groups (battery modules) is provided. On the other hand, a heat transfer member for discharging heat generated in a battery cell group is provided. However, even when the heat transfer member is provided, local heat generation may occur in the battery cell group.

The present disclosure has been made in view of the above-described problem, and an object thereof is to address local heat generation in a battery cell group.

A power storage device according to a first aspect of the present disclosure includes: a battery cell group; a heat insulating member; and a cooling portion. The battery cell group includes a first cell and a second cell arranged in a first direction, and a first heat transfer member and a second heat transfer member arranged in the first direction. The first cell is located farthest in the first direction in the battery cell group. The first heat transfer member is adjacent to the first cell on a second direction side opposite to a first direction side of the first cell. The second heat transfer member is adjacent to the second cell on a second direction side of the second cell. The heat insulating member is made of a material having a thermal conductivity lower than that of each of the first heat transfer member and the second heat transfer member. The heat insulating member is located on a first direction side of the battery cell group. The cooling portion is located on a third direction side of the battery cell group, a third direction being orthogonal to the first direction. The cooling portion is in contact with the first heat transfer member and the second heat transfer member. In the third direction, a thermal resistance of the first heat transfer member is lower than a thermal resistance of the second heat transfer member.

In the first aspect of the present disclosure, the present disclosers have found that in the battery cell group, the temperature of a cell having a specific positional relationship with the heat insulating member is likely to become higher than that of the other cells. That is, the present disclosers have found that when the first cell, the second cell, the first heat transfer member, the second heat transfer member, and the heat insulating member have the above-described positional relationship, the temperature of the first cell is likely to become particularly high. Since the thermal resistance of the first heat transfer member is lower than the thermal resistance of the second heat transfer member, heat generated in the first cell can be more efficiently transmitted to the cooling portion. Therefore, local heat generation in the battery cell group can be suppressed, and thus, local heat generation in the battery cell group can be addressed.

In the power storage device according to the first aspect, preferably, a thickness of the first heat transfer member in the first direction is greater than a thickness of the second heat transfer member in the first direction. With such a configuration, the thermal resistance of the first heat transfer member in the third direction can be more easily made lower than the thermal resistance of the second heat transfer member in the third direction.

The power storage device according to the first aspect preferably further includes one or more resin members. The one or more resin members are made of a material having a thermal conductivity lower than that of each of the first heat transfer member and the second heat transfer member and higher than that of the heat insulating member. One of the one or more resin members is located between the first cell and the second cell. With such a configuration, the pressing force from the first cell to the second cell or the pressing force from the second cell to the first cell can be reduced by the resin member.

In the power storage device according to the first aspect, preferably, the battery cell group includes a plurality of cells arranged in the first direction, and a plurality of heat transfer members arranged in the first direction, the plurality of cells including the first cell, the second cell, and one or more other cells, the plurality of heat transfer members including the first heat transfer member, the second heat transfer member, and one or more other heat transfer members. The plurality of heat transfer members are adjacent to the plurality of cells on second direction sides of the plurality of cells, respectively.

In the first aspect of the present disclosure, the present disclosers have found that even when the plurality of cells, the plurality of heat transfer members and the heat insulating member have such a positional relationship, the temperature of the first cell, of the plurality of cells, is most likely to become high. Therefore, heat generated in the first cell can be transmitted to the cooling portion by the first heat transfer member, and thus, local heat generation in the battery cell group can be more effectively suppressed.

In this case, preferably, when each of the plurality of heat transfer members is adjacent to a corresponding one of the plurality of heat transfer members on a second direction side, a thermal resistance of each of the plurality of heat transfer members in the third direction is lower than that of the corresponding one of the plurality of heat transfer members in the third direction.

In the first aspect of the present disclosure, the present disclosers have found that when the plurality of cells, the plurality of heat transfer members and the heat insulating member have such a positional relationship, the heat generation temperature of a cell located closer to the heat insulating member is likely to become higher. Therefore, in accordance with the degree of heat generation in the plurality of cells, heat generated in the plurality of cells can be transmitted to the cooling portion by the plurality of heat transfer members configured as described above. Thus, local heat generation in the battery cell group can be more effectively suppressed.

In this case, preferably, when each of the plurality of heat transfer members is adjacent to a corresponding one of the plurality of heat transfer members on a second direction side, a thickness of each of the plurality of heat transfer members in the first direction is greater than that of the corresponding one of the plurality of heat transfer members in the first direction. With such a configuration, the thermal resistance of each of the plurality of heat transfer members in the third direction can be more easily made lower than that of the corresponding one of the plurality of heat transfer members in the third direction.

In this case, the power storage device preferably further includes a plurality of resin members. The plurality of resin members are made of a material having a thermal conductivity lower than that of each of the plurality of heat transfer members and higher than that of the heat insulating member. The plurality of resin members are adjacent to the plurality of cells on first direction sides of the plurality of cells, respectively. With such a configuration, the pressing force from each of the plurality of cells to another adjacent cell can be reduced by the plurality of resin members.

In the power storage device according to the first aspect, preferably, in the battery cell group, all of the plurality of heat transfer members are adjacent to the plurality of cells on the second direction sides of all of the plurality of cells, respectively.

In the first aspect of the present disclosure, the present disclosers have found that even when the plurality of cells, the plurality of heat transfer members and the heat insulating member have such a positional relationship, the temperature of the first cell, of the plurality of cells, is most likely to become high. Therefore, heat generated in the first cell can be transmitted to the cooling portion by the first heat transfer member, and thus, local heat generation in the battery cell group can be more effectively suppressed.

A power storage device according to a second aspect of the present disclosure includes: a battery cell group; a heat insulating member; a cooling portion; and a temperature sensor. The battery cell group includes a first cell and a second cell arranged in a first direction, and a first heat transfer member and a second heat transfer member arranged in the first direction. The first cell is located farthest in the first direction in the battery cell group. The first heat transfer member is adjacent to the first cell on a second direction side opposite to a first direction side of the first cell. The second heat transfer member is adjacent to the second cell on a second direction side of the second cell. The heat insulating member is made of a material having a thermal conductivity lower than that of each of the first heat transfer member and the second heat transfer member. The heat insulating member is located on a first direction side of the battery cell group. The cooling portion is located on a third direction side of the battery cell group, a third direction being orthogonal to the first direction. The cooling portion is in contact with the first heat transfer member and the second heat transfer member. The temperature sensor is provided on the first heat transfer member.

In the second aspect of the present disclosure, the present disclosers have found that in the battery cell group, the temperature of a cell having a specific positional relationship with the heat insulating member is likely to become higher than that of the other cells. That is, the present disclosers have found that when the first cell, the second cell, the first heat transfer member, the second heat transfer member, and the heat insulating member have the above-described positional relationship, the temperature of the first cell is likely to become particularly high. Since the temperature sensor is provided on the first heat transfer member, heat generation in the first cell can be detected at a relatively early stage. Therefore, local heat generation in the battery cell group can be detected at a relatively early stage, and thus, local heat generation in the battery cell group can be addressed.

In this case, preferably, the temperature sensor is located on a fourth direction side opposite to the third direction side of the battery cell group. With such a configuration, the temperature sensor is disposed opposite to the cooling portion to which heat generated in the battery cell group is transmitted, when viewed from the battery cell group, and thus, the accuracy of detection of the temperature of the first cell is improved.

The power storage device according to the second aspect preferably further includes one or more resin members. The one or more resin members are made of a material having a thermal conductivity lower than that of each of the first heat transfer member and the second heat transfer member and higher than that of the heat insulating member. One of the one or more resin members is located between the first cell and the second cell. With such a configuration, the pressing force from the first cell to the second cell or the pressing force from the second cell to the first cell can be reduced by the resin member.

In this case, preferably, the temperature sensor includes a terminal and a conducting wire. The terminal is joined to the first heat transfer member. The conducting wire is electrically connected to the terminal. The conducting wire is fixed to at least one of the one or more resin members. With such a configuration, unjoining of the terminal from the first heat transfer member when the pulling force in the direction away from the first heat transfer member acts on the conducting wire can be suppressed.

In the power storage device according to the second aspect, preferably, the battery cell group includes a plurality of cells arranged in the first direction, and a plurality of heat transfer members arranged in the first direction, the plurality of cells including the first cell, the second cell, and one or more other cells, the plurality of heat transfer members including the first heat transfer member, the second heat transfer member, and one or more other heat transfer members. The plurality of heat transfer members are adjacent to the plurality of cells on second direction sides of the plurality of cells, respectively.

In the second aspect of the present disclosure, the present disclosers have found that even when the plurality of cells, the plurality of heat transfer members and the heat insulating member have such a positional relationship, the temperature of the first cell, of the plurality of cells, is most likely to become high. Therefore, the temperature sensor is provided on the first heat transfer member, and thus, local heat generation in the battery cell group can be more effectively detected at an early stage.

In this case, the power storage device preferably further includes a plurality of resin members. The plurality of resin members are made of a material having a thermal conductivity lower than that of each of the plurality of heat transfer members and higher than that of the heat insulating member. The plurality of resin members are adjacent to the plurality of cells on first direction sides of the plurality of cells, respectively. With such a configuration, the pressing force from each of the plurality of cells to another adjacent cell can be reduced by the plurality of resin members.

In this case, preferably, the temperature sensor includes a terminal and a conducting wire. The terminal is joined to the first heat transfer member. The conducting wire is electrically connected to the terminal. The conducting wire is fixed to at least one of the plurality of resin members. With such a configuration, unjoining of the terminal from the first heat transfer member when the pulling force in the direction away from the first heat transfer member acts on the conducting wire can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage device according to an embodiment of the present disclosure.

FIG. 2 is a partially enlarged perspective view showing the power storage device according to the embodiment of the present disclosure.

FIG. 3 is another partially enlarged perspective view showing the power storage device according to the embodiment of the present disclosure.

FIG. 4 is a cross-sectional view of the power storage device in FIG. 3 when viewed in the direction of an arrow IV-IV.

FIG. 5 is a cross-sectional view showing a modification of the power storage device according to the embodiment of the present disclosure.

### DESCRIPTION OF THE PREFERRED EMBODIMENTS

Hereinafter, a power storage device according to an embodiment of the present disclosure will be described with reference to the drawings, in which the same or corresponding portions are denoted by the same reference characters and description thereof will not be repeated.

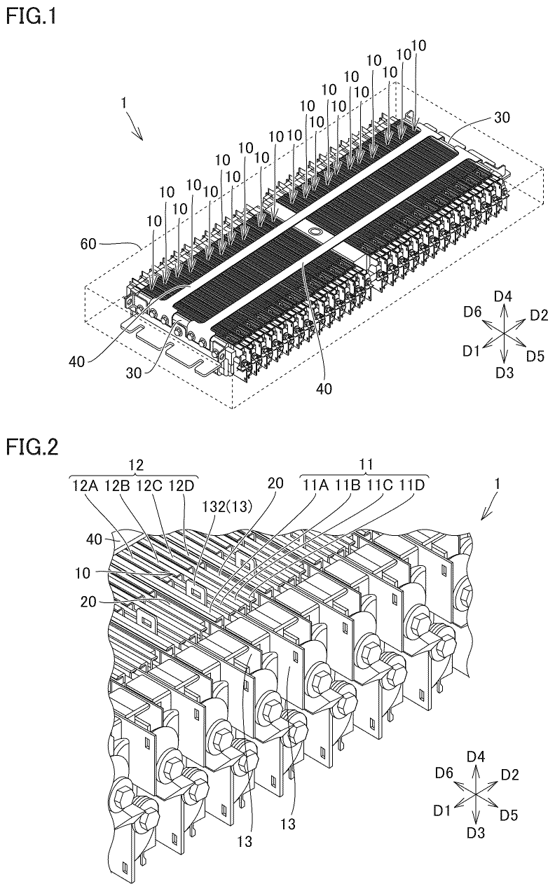

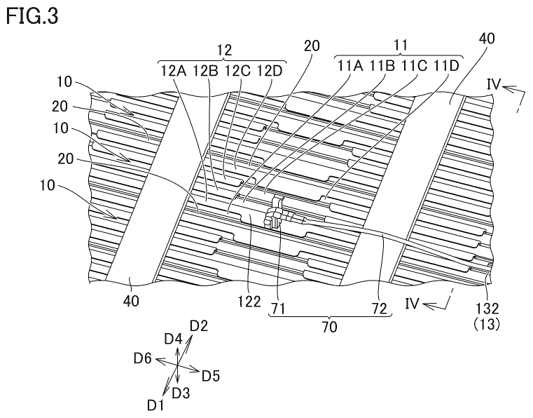

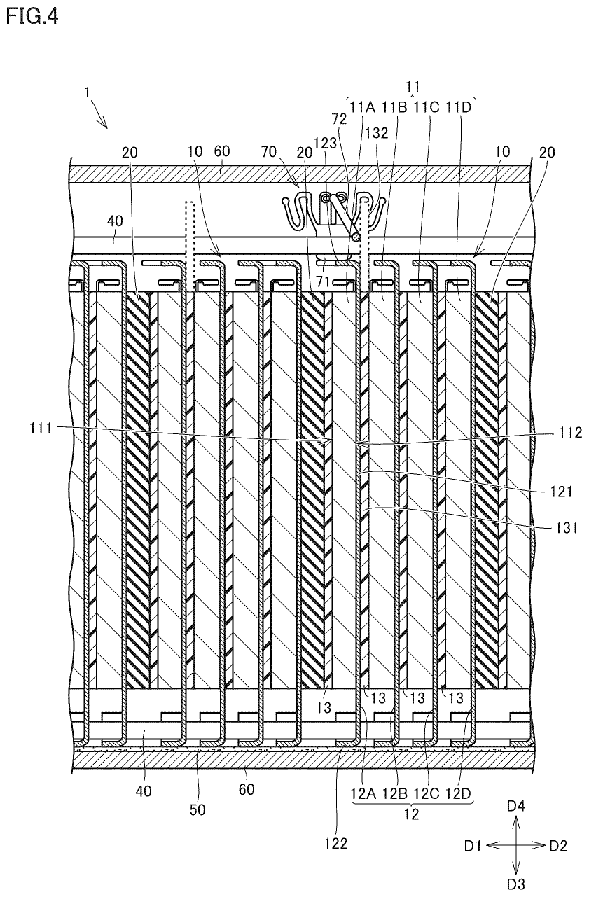

FIG. 1 is a perspective view showing a power storage device according to an embodiment of the present disclosure. FIG. 2 is a partially enlarged perspective view showing the power storage device according to the embodiment of the present disclosure. FIG. 3 is another partially enlarged perspective view showing the power storage device according to the embodiment of the present disclosure. FIG. 4 is a cross-sectional view of the power storage device in FIG. 3 when viewed in the direction of an arrow IV-IV.

Regarding the directions shown in the figures, a second direction D2 is a direction opposite to a first direction D1. A third direction D3 is a direction orthogonal to first direction D1. A fourth direction D4 is a direction opposite to third direction D3. A fifth direction D5 is a direction orthogonal to both first direction D1 and third direction D3. A sixth direction D6 is a direction opposite to fifth direction D5. First direction D1, second direction D2, fifth direction D5, and sixth direction D6 may be directions along the horizontal, for example. Third direction D3 may be a downward direction. Fourth direction D4 may be an upward direction.

As shown in FIGS. 1 to 4, a power storage device 1 includes a plurality of battery cell groups 10, a plurality of resin members 13, a plurality of heat insulating members 20, a pair of end plates 30, a plurality of restraint bands 40, a cooling portion 50, a case 60, and a temperature sensor 70. An outer shape of case 60 is shown by a broken line in FIG. 1. Case 60 is not shown in FIGS. 2 and 3 for convenience of description. Temperature sensor 70 is not shown in FIG. 2 for convenience of description.

Power storage device 1 may be power storage device 1 mounted on a vehicle. When power storage device 1 is mounted on a vehicle, one of first direction D1 and second direction D2 may be a forward direction of the vehicle, and the other may be a rearward direction of the vehicle. One of first direction D1 and second direction D2 may be a left direction of the vehicle, and the other may be a right direction of the vehicle.

In the present embodiment, power storage device 1 includes the plurality of battery cell groups 10. The plurality of battery cell groups 10 are arranged in first direction D1.

Each of battery cell groups 10 includes a plurality of cells 11 and a plurality of heat transfer members 12. Each of the plurality of cells 11 is, for example, an all-solid-state battery including a solid electrolyte. However, each of the plurality of cells 11 may be a polymer battery, or may be a liquid-type battery such as a lithium ion secondary battery.

Each of the plurality of cells 11 has a substantially rectangular parallelepiped outer shape. Each of the plurality of cells 11 has a first side surface portion 111 and a second side surface portion 112. First side surface portion 111 faces first direction D1. Second side surface portion 112 faces second direction D2. First side surface portion 111 and second side surface portion 112 are both flat. First side surface portion 111 and second side surface portion 112 have a substantially rectangular outer shape when viewed from the first direction D1 side and the second direction D2 side, respectively.

The plurality of cells 11 are arranged in first direction D1. The plurality of cells 11 include a first cell 11A and a second cell 11B. Specifically, the plurality of cells 11 include first cell 11A, second cell 11B, and one or more other cells. The plurality of cells 11 include a third cell 11C and a fourth cell 11D as the one or more other cells. As described above, the plurality of cells 11 may include only four cells. The plurality of cells 11 may include only first cell 11A and second cell 11B. The plurality of cells 11 may include five or more cells.

First cell 11A is located farthest in first direction D1 in the plurality of cells 11. First cell 11A is located farthest in first direction D1 in battery cell group 10. Second cell 11B is located on a second direction D2 side of first cell 11A. Third cell 11C is located on a second direction D2 side of second cell 11B. Fourth cell 11D is located on a second direction D2 side of third cell 11C. Fourth cell 11D is located farthest in second direction D2 in the plurality of cells 11.

The plurality of heat transfer members 12 are made of metal. The plurality of heat transfer members 12 are made of, for example, aluminum or an aluminum alloy. In the present embodiment, the plurality of heat transfer members 12 may be made of the same material, or may be made of different materials.

The plurality of heat transfer members 12 are arranged in first direction D1. The plurality of heat transfer members 12 include a first heat transfer member 12A and a second heat transfer member 12B. Specifically, the plurality of heat transfer members 12 include first heat transfer member 12A, second heat transfer member 12B, and one or more other heat transfer members. The plurality of heat transfer members 12 include a third heat transfer member 12C and a fourth heat transfer member 12D as the one or more other heat transfer members. As described above, the plurality of heat transfer members 12 may include only four heat transfer members. The plurality of heat transfer members 12 may include only two heat transfer members. The plurality of heat transfer members 12 may include five or more heat transfer members.

First heat transfer member 12A is located farthest in first direction D1 in the plurality of heat transfer members 12. First heat transfer member 12A is adjacent to first cell 11A of the plurality of cells 11 on the second direction D2 side of first cell 11A. First heat transfer member 12A is in direct contact with first cell 11A.

Second heat transfer member 12B is adjacent to second cell 11B of the plurality of cells 11 on the second direction D2 side of second cell 11B. Second heat transfer member 12B is in direct contact with second cell 11B.

Third heat transfer member 12C is adjacent to third cell 11C of the plurality of cells 11 on the second direction D2 side of third cell 11C. Third heat transfer member 12C is in direct contact with third cell 11C.

Fourth heat transfer member 12D is adjacent to fourth cell 11D of the plurality of cells 11 on the second direction D2 side of fourth cell 11D. Fourth heat transfer member 12D is in direct contact with fourth cell 11D. Fourth heat transfer member 12D is located farthest in second direction D2 in the plurality of heat transfer members 12.

As described above, the plurality of heat transfer members 12 are adjacent to the plurality of cells 11 on the second direction D2 sides of the plurality of cells 11, respectively, such that the plurality of heat transfer members 12 correspond to the plurality of cells 11 in one-to-one relationship. More specifically, in battery cell group 10, all of the plurality of heat transfer members 12 are adjacent to the plurality of cells 11 on the second direction D2 sides of all of the plurality of cells 11, respectively. Each of the plurality of heat transfer members 12 is in direct contact with cell 11 adjacent thereto on a first direction D1 side thereof. When cell 11 is located on a second direction D2 side of heat transfer member 12, each of the plurality of heat transfer members 12 does not necessarily need to be in direct contact with cell 11 located on the second direction D2 side.

Each of the plurality of heat transfer members 12 has a plate-shaped portion 121, a first extending portion 122 and a second extending portion 123. Plate-shaped portion 121 extends along third direction D3. Plate-shaped portion 121 protrudes to a third direction D3 side with respect to the plurality of cells 11. Plate-shaped portion 121 protrudes to a fourth direction D4 side with respect to the plurality of cells 11.

First extending portion 122 extends from an end of plate-shaped portion 121 on the third direction D3 side toward first direction D1. In the present embodiment, in any of the plurality of heat transfer members 12, first extending portion 122 extends toward first direction D1. However, first extending portion 122 may extend toward second direction D2. Each of the plurality of heat transfer members 12 may have a plurality of first extending portions 122.

Second extending portion 123 extends from an end of plate-shaped portion 121 on the fourth direction D4 side toward first direction D1. In the present embodiment, in any of the plurality of heat transfer members 12, second extending portion 123 extends toward first direction D1. However, second extending portion 123 may extend toward second direction D2. Each of the plurality of heat transfer members 12 may have a plurality of second extending portions 123.

The plurality of resin members 13 are made of a material having a thermal conductivity lower than that of each of first heat transfer member 12A and second heat transfer member 12B and higher than that of each of heat insulating members 20. The plurality of resin members 13 are made of a material having a thermal conductivity lower than that of each of the plurality of heat transfer members 12. The plurality of resin members 13 may be made of the same material, or may be made of different materials.

One of the plurality of resin members 13 is located between first cell 11A and second cell 11B. With such a configuration, the pressing force from first cell 11A to second cell 11B or the pressing force from second cell 11B to first cell 11A can be reduced by resin member 13.

In the present embodiment, the plurality of resin members 13 are adjacent to the plurality of cells 11 on the first direction D1 sides of the plurality of cells 11, respectively, such that the plurality of resin members 13 correspond to the plurality of cells 11 in one-to-one relationship. With such a configuration, the pressing force from each of the plurality of cells 11 to another adjacent cell 11 can be reduced by the plurality of resin members 13. Each of the plurality of resin members 13 is in direct contact with cell 11 adjacent thereto on a first direction D1 side thereof.

The plurality of heat transfer members 12 also protrude to the third direction D3 side with respect to the plurality of resin members 13. That is, plate-shaped portion 121 protrudes to the third direction D3 side with respect to the plurality of resin members 13. Plate-shaped portion 121 protrudes to the fourth direction D4 side with respect to the plurality of resin members 13.

In addition, in battery cell group 10, at least one resin member 13 has a main body portion 131 and a protruding portion 132. For the sake of convenience, protruding portion 132 located in front with respect to the sheet plane is shown by a broken line in FIG. 4.

Main body portion 131 is arranged side by side with the plurality of cells 11 and the plurality of heat transfer members 12 in first direction D1. A dimension of main body portion 131 in first direction D1 is smaller than a dimension of each of the plurality of heat transfer members 12 in first direction D1. Plate-shaped portion 121 protrudes to the fourth direction D4 side with respect to main body portion 131.

Protruding portion 132 protrudes from main body portion 131 in fourth direction D4. Protruding portion 132 protrudes in fourth direction D4 with respect to the plurality of heat transfer members 12. Protruding portion 132 may be provided with a hole extending through protruding portion 132 in first direction D1. In battery cell group 10, at least one of other resin members 13 does not necessarily need to have protruding portion 132.

In the present embodiment, resin member 13 adjacent to second cell 11B has protruding portion 132. In other words, resin member 13 adjacent to first heat transfer member 12A has protruding portion 132.

Resin member 13 may have another configuration. For example, resin member 13 may have a fastening portion to which a bus bar that electrically connects the plurality of cells 11 is fastened, or may have a pedestal on which the bus bar is placed.

Examples of a resin contained in resin member 13 as a main component include an olefin-based resin such as polypropylene (PP) or polyester (PE), a polyester-based resin such as polyethylene terephthalate (PET), and the like. Alternatively, resin member 13 may be made of so-called engineering plastic including polyphenylene sulfide (PPS) or polyetheretherketone (PEEK).

Each of the plurality of heat insulating members 20 is made of a material having a thermal conductivity lower than that of each of first heat transfer member 12A and second heat transfer member 12B. Each of the plurality of heat insulating members 20 is made of a material having a thermal conductivity lower than that of each of the plurality of heat transfer members 12 and each of the plurality of resin members 13. A dimension of each of the plurality of heat insulating members 20 in first direction D1 is larger than a dimension of plate-shaped portion 121 of each of the plurality of heat transfer members 12 in first direction D1. A dimension of each of the plurality of heat insulating members 20 in first direction D1 is larger than a dimension of each of the plurality of resin members 13 in first direction D1.

The plurality of heat insulating members 20 are located on first direction D1 sides of the plurality of battery cell groups 10, respectively. Each of the plurality of heat insulating members 20 is in direct contact with resin member 13 adjacent thereto on a second direction D2 side thereof. That is, resin member 13 that is in direct contact with each of the plurality of heat insulating members 20 on the second direction D2 side of each of the plurality of heat insulating members 20 is resin member 13 that is in direct contact with first cell 10A. Each of the plurality of heat insulating members 20 is in direct contact with heat transfer member 12 of battery cell group 10 adjacent thereto on a first direction D1 side thereof. Specifically, each of the plurality of heat insulating members 20 is in direct contact with fourth heat transfer member 12D on the first direction D1 side thereof. As described above, the plurality of heat insulating members 20 and the plurality of battery cell groups 10 are alternately disposed in first direction D1.

The pair of end plates 30 are disposed on the first direction D1 side and the second direction D2 side, respectively, with respect to the plurality of battery cell groups 10 and the plurality of heat insulating members 20.

An end of each of the plurality of restraint bands 40 on a first direction D1 side is coupled to one of the pair of end plates 30. An end of each of the plurality of restraint bands 40 on a second direction D2 side is coupled to the other of the pair of end plates 30.

Cooling portion 50 is located on a third direction D3 side of battery cell group 10 orthogonal to first direction D1. Cooling portion 50 is preferably made of a material having a relatively low thermal conductivity. Although cooling portion 50 is in a paste or gel form, cooling portion 50 may be in a sheet form, for example. Cooling portion 50 may be a thermally conductive adhesive. Cooling portion 50 may be a bottom portion of case 60 described below.

Cooling portion 50 is in contact with first heat transfer member 12A and second heat transfer member 12B. Cooling portion 50 is in contact with the plurality of heat transfer members 12. Specifically, cooling portion 50 is in contact with first extending portion 122 of each of the plurality of heat transfer members 12. This makes a contact area between heat transfer members 12 and cooling portion 50 relatively larger, and thus, heat is easier to move from heat transfer members 12 to cooling portion 50. Cooling portion 50 may be spaced apart from the plurality of cells 11, the plurality of resin members 13 and the plurality of heat insulating members 20.

Case 60 houses the plurality of battery cell groups 10, the plurality of heat insulating members 20, the pair of end plates 30, restraint bands 40, and cooling portion 50. The plurality of battery cell groups 10 are supported by the plurality of heat transfer members 12 in case 60. The plurality of heat transfer members 12 are joined to the bottom portion of case 60 through cooling portion 50. The plurality of cells 11 are spaced apart from case 60. Therefore, the reaction force from case 60 can be suppressed.

Local heat generation in battery cell group 10 in power storage device 1 according to the embodiment of the present disclosure will now be described.

First, the description focuses on cells 11 other than first cell 11A, such as second cell 11B, third cell 11C and fourth cell 11D, in battery cell group 10. In each of cells 11 other than first cell 11A, heat transfer members 12 are disposed on both the first direction D1 side and the second direction D2 side. In each of cells 11 other than first cell 11A, heat insulating member 20 is not disposed between cell 11 and heat transfer member 12. Therefore, heat generated from cell 11 other than first cell 11A is relatively easily transmitted from heat transfer members 12 on both sides to cooling portion 50. When resin member 13 is located between heat transfer member 12 and cell 11, the heat is transmitted through resin member 13.

In each of cells 11 other than first cell 11A, heat can be transmitted from cell 11 adjacent thereto on the first direction D1 side thereof through heat transfer member 12 and resin member 13. However, the heat can be transmitted to cooling portion 50 by heat transfer member 12 on the second direction D2 side.

In addition, in each of cells 11 other than cell 11 located farthest in second direction D2 (in the present embodiment, fourth cell 11D), of the plurality of cells 11 in battery cell group 10, heat can be transmitted from cell 11 adjacent thereto on the second direction D2 side thereof through resin member 13 and heat transfer member 12. In each of cells 11 other than first cell 11A, the heat can be transmitted to cooling portion 50 by heat transfer member 12 on the first direction D1 side.

Next, the description focuses on first cell 11A. Heat generated from first cell 11A is transmitted from first heat transfer member 12A to cooling portion 50. In addition, the heat generated from first cell 11A is transmitted in second direction D2 through first heat transfer member 12A. However, heat transfer member 12 is not disposed between first cell 11A and heat insulating member 20 disposed on the first direction D1 side of first cell 11A. Therefore, transmission of the heat generated from first cell 11A in first direction D1 is more difficult, as compared with cells 11 other than first cell 11A. Furthermore, in first cell 11A, transmission of heat from another cell 11 on the second direction D2 side to cooling portion 50 is also difficult.

Therefore, in battery cell group 10 having the above-described configuration, the temperature of first cell 11A, of the plurality of cells 11, is most likely to become high. In battery cell group 10 having the above-described configuration, local heat generation is likely to occur in first cell 11A.

Thus, in power storage device 1 according to the present embodiment, temperature sensor 70 is provided on first heat transfer member 12A. The temperature of first cell 11A is measured by temperature sensor 70 through first heat transfer member 12A. Therefore, heat generation in first cell 11A whose temperature is most likely to become high, of the plurality of cells 11, can be detected at a relatively early stage. Therefore, local heat generation in battery cell group 10 can be detected at a relatively early stage, and thus, local heat generation in battery cell group 10 can be addressed.

Temperature sensor 70 is located on a fourth direction D4 side opposite to the third direction D3 side of battery cell group 10. With such a configuration, temperature sensor 70 is disposed opposite to cooling portion 50 to which heat generated in battery cell group 10 is transmitted, when viewed from battery cell group 10, and thus, the accuracy of detection of the temperature of first cell 11A is improved.

Temperature sensor 70 includes a terminal 71 and a conducting wire 72. Terminal 71 is joined to first heat transfer member 12A. Conducting wire 72 is electrically connected to terminal 71. Conducting wire 72 is fixed to at least one of one or more resin members 13. In the present embodiment, conducting wire 72 is fixed to at least one of the plurality of resin members 13. With such a configuration, unjoining of terminal 71 from first heat transfer member 12A when the pulling force in the direction away from first heat transfer member 12A acts on conducting wire 72 can be suppressed.

In the present embodiment, terminal 71 is joined to second extending portion 123 by an adhesive or the like. Conducting wire 72 is fixed to protruding portion 132. Since protruding portion 132 protrudes in fourth direction D4, protruding portion 132 can easily fix conducting wire 72. Conducting wire 72 may be fixed to protruding portion 132 by a restraint member (not shown) such as a cable tie inserted into a hole formed in protruding portion 132.

Furthermore, in the present embodiment, in third direction D3, a thermal resistance of first heat transfer member 12A is lower than a thermal resistance of second heat transfer member 12B. More specifically, when each of the plurality of heat transfer members 12 is adjacent to a corresponding one of the plurality of heat transfer members 12 on the second direction D2 side, a thermal resistance of each of the plurality of heat transfer members 12 in third direction D3 is lower than a thermal resistance of the corresponding one of the plurality of heat transfer members 12 in third direction D3. Therefore, the heat generated in first cell 11A whose temperature is most likely to become high, of the plurality of cells 11, can be more efficiently transmitted to cooling portion 50. Therefore, local heat generation in battery cell group 10 can be suppressed, and thus, local heat generation in battery cell group 10 can be addressed.

In the present embodiment, a thermal conductivity of a material of first heat transfer member 12A is higher than a thermal conductivity of a material of second heat transfer member 12B. More specifically, when each of the plurality of heat transfer members 12 is adjacent to a corresponding one of the plurality of heat transfer members 12 on the second direction D2 side, a thermal conductivity of a material of each of the plurality of heat transfer members 12 is higher than a thermal conductivity of a material of the corresponding one of the plurality of heat transfer members 12. With such a configuration, a value of the thermal resistance of each of heat transfer members 12 in third direction D3 can relatively easily have the above-described relationship. In the present embodiment, the plurality of heat transfer members 12 may have the same dimension in first direction D1. Plate-shaped portions 121 of the plurality of heat transfer members 12 may have the same dimension in first direction D1.

The configuration of each of heat transfer members 12 that allows the value of the thermal resistance to have the above-described relationship is not limited to the above-described configuration.

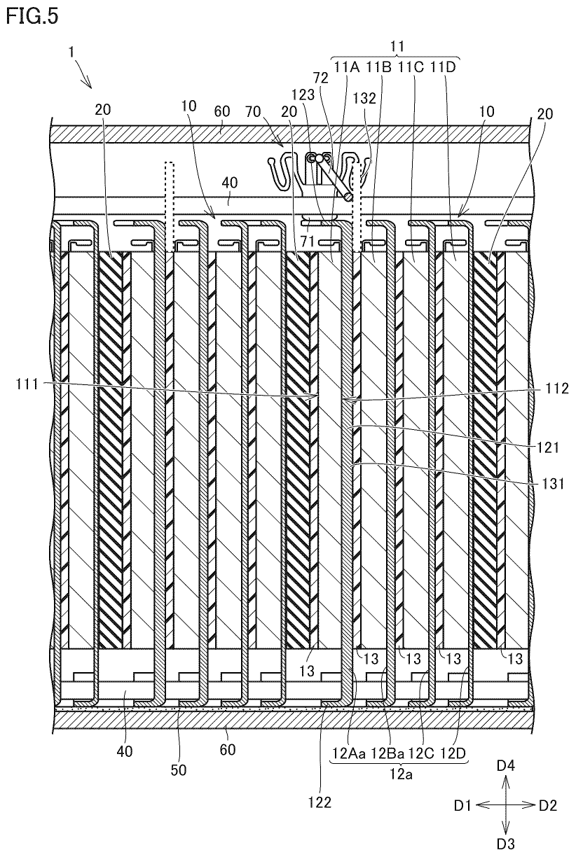

FIG. 5 is a cross-sectional view showing a modification of the power storage device according to the embodiment of the present disclosure. FIG. 5 is illustrated in the same cross-sectional view as FIG. 4.

As shown in FIG. 5, in the present modification, a thickness of a first heat transfer member 12Aa in first direction D1 is greater than a thickness of a second heat transfer member 12Ba in first direction D1. More specifically, when each of the plurality of heat transfer members 12a is adjacent to a corresponding one of the plurality of heat transfer members 12a on the second direction side, a thickness of each of the plurality of heat transfer members 12a in first direction D1 is greater than a thickness of the corresponding one of the plurality of heat transfer members 12a in first direction D1. With such a configuration, a value of a thermal resistance of each of heat transfer members 12a in third direction D3 can more easily have the above-described relationship. In the present modification, the plurality of heat transfer members 12a may be made of the same material.

In the description of the above-described embodiment and modification, the features that can be combined may be combined mutually.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a battery cell group;
a heat insulating member; and
a cooling portion, wherein
the battery cell group includes a first cell and a second cell arranged in a first direction, and a first heat transfer member and a second heat transfer member arranged in the first direction,
the first cell is located farthest in the first direction in the battery cell group,
the first heat transfer member is adjacent to the first cell on a second direction side opposite to a first direction side of the first cell,
the second heat transfer member is adjacent to the second cell on a second direction side of the second cell,
the heat insulating member is made of a material having a thermal conductivity lower than that of each of the first heat transfer member and the second heat transfer member,
the heat insulating member is located on a first direction side of the battery cell group,
the cooling portion is located on a third direction side of the battery cell group, a third direction being orthogonal to the first direction,
the cooling portion is in contact with the first heat transfer member and the second heat transfer member, and
in the third direction, a thermal resistance of the first heat transfer member is lower than a thermal resistance of the second heat transfer member.

2. The power storage device according to claim 1, wherein
a thickness of the first heat transfer member in the first direction is greater than a thickness of the second heat transfer member in the first direction.

3. The power storage device according to claim 1, further comprising one or more resin members, wherein
the one or more resin members are made of a material having a thermal conductivity lower than that of each of the first heat transfer member and the second heat transfer member and higher than that of the heat insulating member, and
one of the one or more resin members is located between the first cell and the second cell.

4. The power storage device according to claim 1, wherein
the battery cell group includes a plurality of cells arranged in the first direction, and a plurality of heat transfer members arranged in the first direction, the plurality of cells including the first cell, the second cell, and one or more other cells, the plurality of heat transfer members including the first heat transfer member, the second heat transfer member, and one or more other heat transfer members, and
the plurality of heat transfer members are adjacent to the plurality of cells on second direction sides of the plurality of cells, respectively.

5. The power storage device according to claim 4, wherein
when each of the plurality of heat transfer members is adjacent to a corresponding one of the plurality of heat transfer members on a second direction side, a thermal resistance of each of the plurality of heat transfer members in the third direction is lower than that of the corresponding one of the plurality of heat transfer members in the third direction.

6. The power storage device according to claim 5, wherein
when each of the plurality of heat transfer members is adjacent to a corresponding one of the plurality of heat transfer members on a second direction side, a thickness of each of the plurality of heat transfer members in the first direction is greater than that of the corresponding one of the plurality of heat transfer members in the first direction.

7. The power storage device according to claim 4, further comprising a plurality of resin members, wherein
the plurality of resin members are made of a material having a thermal conductivity lower than that of each of the plurality of heat transfer members and higher than that of the heat insulating member, and
the plurality of resin members are adjacent to the plurality of cells on first direction sides of the plurality of cells, respectively.

8. The power storage device according to claim 4, wherein
in the battery cell group, all of the plurality of heat transfer members are adjacent to the plurality of cells on the second direction sides of all of the plurality of cells, respectively.

9. A power storage device comprising:
a battery cell group;
a heat insulating member;
a cooling portion; and
a temperature sensor, wherein
the battery cell group includes a first cell and a second cell arranged in a first direction, and a first heat transfer member and a second heat transfer member arranged in the first direction,
the first cell is located farthest in the first direction in the battery cell group,
the first heat transfer member is adjacent to the first cell on a second direction side opposite to a first direction side of the first cell,
the second heat transfer member is adjacent to the second cell on a second direction side of the second cell,
the heat insulating member is made of a material having a thermal conductivity lower than that of each of the first heat transfer member and the second heat transfer member,
the heat insulating member is located on a first direction side of the battery cell group,
the cooling portion is located on a third direction side of the battery cell group, a third direction being orthogonal to the first direction,
the cooling portion is in contact with the first heat transfer member and the second heat transfer member, and
the temperature sensor is provided on the first heat transfer member.

10. The power storage device according to claim 9, wherein
the temperature sensor is located on a fourth direction side opposite to the third direction side of the battery cell group.

11. The power storage device according to claim 9, further comprising one or more resin members, wherein
the one or more resin members are made of a material having a thermal conductivity lower than that of each of the first heat transfer member and the second heat transfer member and higher than that of the heat insulating member, and
one of the one or more resin members is located between the first cell and the second cell.

12. The power storage device according to claim 11, wherein
the temperature sensor includes a terminal and a conducting wire,
the terminal is joined to the first heat transfer member,
the conducting wire is electrically connected to the terminal, and
the conducting wire is fixed to at least one of the one or more resin members.

13. The power storage device according to claim 9, wherein
the battery cell group includes a plurality of cells arranged in the first direction, and a plurality of heat transfer members arranged in the first direction, the plurality of cells including the first cell, the second cell, and one or more other cells, the plurality of heat transfer members including the first heat transfer member, the second heat transfer member, and one or more other heat transfer members, and
the plurality of heat transfer members are adjacent to the plurality of cells on second direction sides of the plurality of cells, respectively.

14. The power storage device according to claim 13, further comprising a plurality of resin members, wherein
the plurality of resin members are made of a material having a thermal conductivity lower than that of each of the plurality of heat transfer members and higher than that of the heat insulating member, and
the plurality of resin members are adjacent to the plurality of cells on first direction sides of the plurality of cells, respectively.

15. The power storage device according to claim 14, wherein
the temperature sensor includes a terminal and a conducting wire,
the terminal is joined to the first heat transfer member,
the conducting wire is electrically connected to the terminal, and
the conducting wire is fixed to at least one of the plurality of resin members.

16. The power storage device according to claim 2, further comprising one or more resin members, wherein
the one or more resin members are made of a material having a thermal conductivity lower than that of each of the first heat transfer member and the second heat transfer member and higher than that of the heat insulating member, and
one of the one or more resin members is located between the first cell and the second cell.

17. The power storage device according to claim 10, further comprising one or more resin members, wherein
the one or more resin members are made of a material having a thermal conductivity lower than that of each of the first heat transfer member and the second heat transfer member and higher than that of the heat insulating member, and
one of the one or more resin members is located between the first cell and the second cell.

18. The power storage device according to claim 17, wherein
the temperature sensor includes a terminal and a conducting wire,
the terminal is joined to the first heat transfer member,
the conducting wire is electrically connected to the terminal, and
the conducting wire is fixed to at least one of the one or more resin members.

19. The power storage device according to claim 10, wherein
the battery cell group includes a plurality of cells arranged in the first direction, and a plurality of heat transfer members arranged in the first direction, the plurality of cells including the first cell, the second cell, and one or more other cells, the plurality of heat transfer members including the first heat transfer member, the second heat transfer member, and one or more other heat transfer members, and
the plurality of heat transfer members are adjacent to the plurality of cells on second direction sides of the plurality of cells, respectively.

20. The power storage device according to claim 19, further comprising a plurality of resin members, wherein
the plurality of resin members are made of a material having a thermal conductivity lower than that of each of the plurality of heat transfer members and higher than that of the heat insulating member, and
the plurality of resin members are adjacent to the plurality of cells on first direction sides of the plurality of cells, respectively.
